(19) United States
(12) Patent Application Publication
(10) Pub. No.: US 2025/0365539 A1
(43) Pub. Date: Nov. 27, 2025

(54) MULTI-VEHICLE EXTERIOR AUDIO SYNCHRONIZATION SYSTEMS AND METHODS

(71) Applicant: Ford Global Technologies, LLC, Dearborn, MI (US)

(72) Inventors: Matt Jones, Beaverton, OR (US); Brian Schabel, Northville, MI (US); Lee Mitchell Tome, Windsor (CA); Milan Podhorsky, Milford, MI (US); Joshua Wheeler, Trenton, MI (US)

(73) Assignee: Ford Global Technologies, LLC, Dearborn, MI (US)

(21) Appl. No.: 18/669,597

(22) Filed: May 21, 2024

(51) Int. Cl. H04R 3/12; H04R 5/02; H04S 7/00

(52) U.S. Cl. CPC H04R 3/12; H04R 5/02; H04S 7/301; H04R 2499/13; H04S 2400/11

(57) ABSTRACT

An audio synchronization system including a transceiver and a processor is disclosed. The transceiver may be configured to obtain inputs from a plurality of vehicles. Each vehicle may include a plurality of exterior audio systems disposed at a vehicle exterior surface. The processor may obtain inputs from the transceiver, and determine a position of each exterior audio system relative to the audio synchronization system based on the inputs. Based on the position, the processor may determine a calibration setting of one or more exterior audio systems for each vehicle based on the position, and output information associated with the calibration setting to each vehicle to cause each vehicle to synchronize one or more exterior audio systems based on the calibration setting.

### FIELD

The present disclosure relates to systems and methods for synchronizing exterior audio in multiple vehicles.

### BACKGROUND

People gather to celebrate different kinds of occasions for entertainment. For example, people celebrate birthdays, graduation ceremonies, and the like. Similarly, people go out for picnics, camps, events, or other outdoor activities with their family and friends. In such gatherings, people typically use multiple audio systems or speakers for entertainment. Such speaker systems generally consume considerable storage space, and hence are not convenient to transport for outdoor gatherings.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in accordance with the present disclosure.

FIG. 2 depicts a block diagram of an audio synchronization system and a vehicle in accordance with the present disclosure.

FIG. 3 depicts an example embodiment of a first vehicle configuration for a multi-vehicle exterior audio experience in accordance with the present disclosure.

FIG. 4 depicts an example embodiment of a second vehicle configuration for a multi-vehicle exterior audio experience in accordance with the present disclosure.

FIG. 5 depicts an example embodiment of a third vehicle configuration for a multi-vehicle exterior audio experience in accordance with the present disclosure.

FIG. 6 depicts a flow diagram of an example audio synchronization method in accordance with the present disclosure.

### DETAILED DESCRIPTION

### Overview

The present disclosure describes a vehicle having a plurality of exterior audio systems that may be disposed/mounted at a vehicle exterior surface. Each exterior audio system may be a vibration exciter (or a speaker) configured to produce audio signals. The vehicle may be configured to communicatively couple with other vehicles (located in proximity to the vehicle) to output same audio signals towards a desired listening location/area (or a target location/area). The vehicle may become a “primary vehicle” that produces/generates the audio content and transmits the audio content to the other vehicles, which may act as or become “replicator vehicles” that play the audio content received from the primary vehicle.

The present disclosure further describes an audio synchronization system (“system”) that may be configured to synchronize sound output from the exterior audio systems of each vehicle such that a user located at the desired listening location may experience an enhanced audio experience. In some aspects, the system may determine a position of each exterior audio system of each vehicle and determine a calibration setting of each exterior audio system based on the position to synchronize the sound output and output the same audio content from multiple vehicles. In some aspects, the calibration setting may include an optimal time delay (or a playback delay) associated with audio output from each external audio system.

In some aspects, the system may request the vehicles to transmit test audio signals to determine the position of the exterior audio systems. Responsive to receiving the test audio signals, the system may determine a time-of-flight of each signal and calculate the position based on time-of-flight. In other aspects, the system may determine the position by using one or more wireless positioning technologies, e.g., by using ultra-wideband (UWB) transceivers, Bluetooth transceivers, gyroscopes, compass, Global Positioning System (GPS) receivers, and/or the like.

In addition, the system may be configured to select one or more exterior audio systems of each vehicle to output the audio signals and determine the calibration settings of the selected exterior audio systems. In some aspects, the system may determine a “usefulness” of each exterior audio system to produce the audio content at the desired listening location and select one or more exterior audio systems of each vehicle to activate based on the respective usefulness.

Responsive to determining the calibration setting of the exterior audio systems, the system may output or transmit an instruction to the respective vehicles to operate the exterior audio systems based on the calibration setting. In addition, the system may output or transmit the instruction to activate only the selected external audio systems. The vehicle may obtain the instruction(s) from the system and may activate/operate the exterior audio systems based on the instructions.

In further aspects, the system may be configured to determine an optimal position of each vehicle to output the audio signals towards the desired listening location/area and may transmit another instruction to the vehicles to move to the respective optimal positions. The vehicles may obtain the instruction and may autonomously move to their respective optimal positions.

The present disclosure discloses an audio synchronization system that enables a user to experience an enhanced audio experience at a desired listening location/area by using multiple vehicles. In addition, the system may prevent noise pollution by activating selected exterior audio systems that may be useful for the enhanced audio experience at the desired listening location. The system eliminates the need for the user to manually manage a plurality of external speakers, thereby considerably enhancing user convenience.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

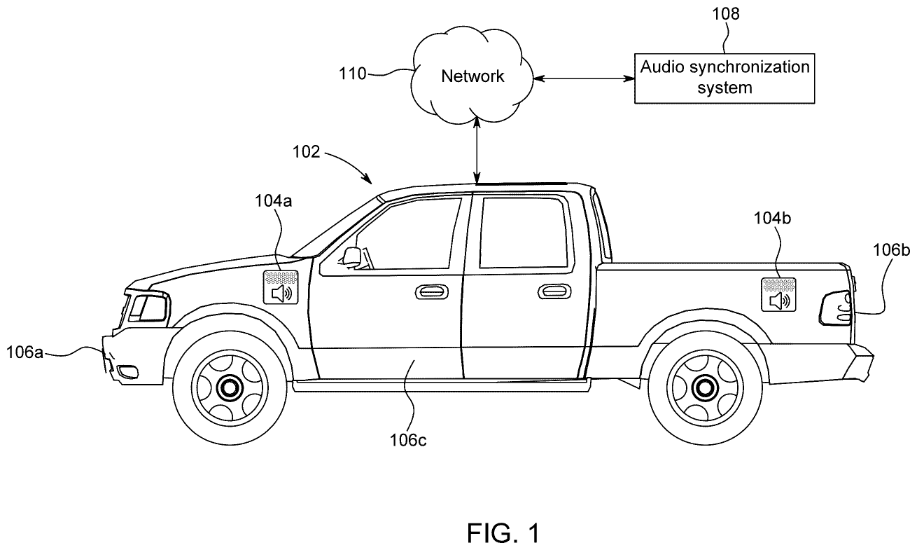

FIG. 1 depicts an example vehicle 102 in accordance with the present disclosure. The vehicle 102 may take the form of any passenger or commercial vehicle such as a car, a work vehicle, a crossover vehicle, a truck, a van, a minivan, a taxi, a bus, etc. Further, the vehicle 102 may be a manually driven vehicle and/or may be configured to operate in a fully autonomous (e.g., driverless) mode or a partially autonomous mode and may include any powertrain such as a gasoline engine, one or more electrically-actuated motor(s), a hybrid system, etc.

The vehicle 102 may have a plurality of exterior audio systems 104a, 104b (collectively referred to as exterior audio systems 104) disposed/mounted on the vehicle 102. The exterior audio systems 104 may be any audio system/speaker system that may be mounted on an exterior surface of the vehicle 102. The exterior audio systems 104 may be mounted at different locations on the vehicle 102. For example, the exterior audio systems 104 may be mounted at or in proximity to a vehicle front portion 106a, a vehicle back portion 106b, a vehicle left portion 106c (e.g., a driver side portion), and a vehicle right side (e.g., a passenger side portion, not shown in FIG. 1). In one exemplary aspect, the vehicle 102 may include one exterior audio system 104 at the vehicle front portion 106a, one exterior audio system 104 at the vehicle back portion 106b, two exterior audio systems 104 at the vehicle left portion 106c (e.g., one towards the vehicle front portion 106a and another towards the vehicle back portion 106b), and two exterior audio systems 104 at the vehicle right portion (e.g., one towards the vehicle front portion 106a and another towards the vehicle back portion 106b). In some aspects, the exterior audio systems 104 may be located on B-side of vehicle outer panels. In other aspects, the exterior audio systems 104 may be disposed in any other arrangement, different from the arrangement described above, without departing from the present disclosure scope.

In an exemplary aspect, each exterior audio system 104 may be or include a vibration exciter that may be disposed at the vehicle exterior surface. The vibration exciter may be integrated or removably coupled to the vehicle exterior surface. The vibration exciter may generate structure borne vibrations that may contact vehicle outer body panel and produce airborne sound radiating outwards from the vehicle 102. Stated another way, the vibration exciter may create sound waves by causing a surface (e.g., the vehicle exterior surface) to vibrate, which enables the vehicle exterior surface to act like a loudspeaker.

In another exemplary aspect, the exterior audio system 104 may be or include a speaker that may be integrated or removably coupled to the vehicle exterior surface. A vehicle user and/or the vehicle 102 may use the exterior audio systems 104 to play audio content. For example, the exterior audio systems 104 may be used for entertainment purpose (e.g., at picnics, outdoor events/parties, etc.) or for outputting information (e.g., to indicate information associated with a vehicle tail gate mode, a charge status, an on-board scale, and/or the like).

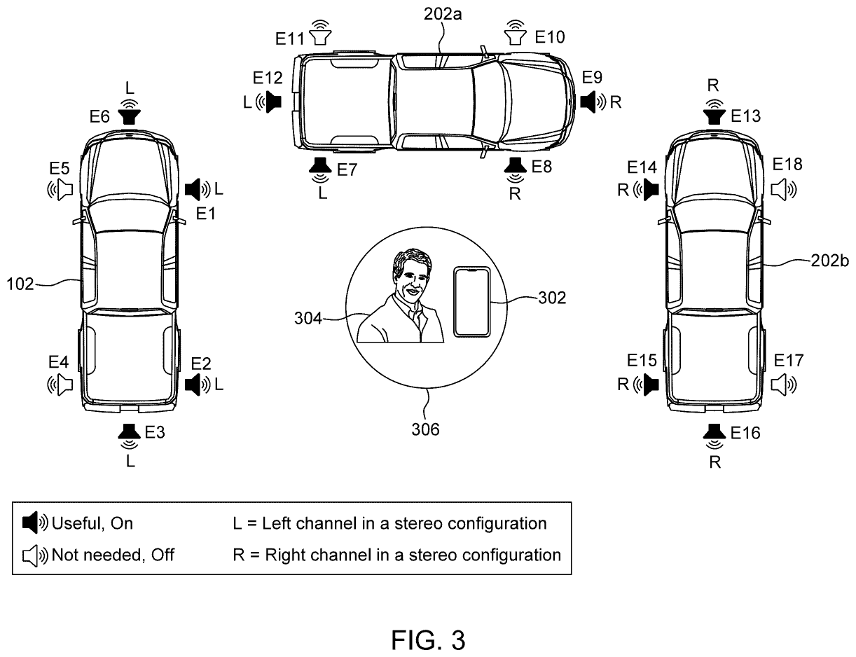

In addition to playing/outputting the audio content via the exterior audio systems 104, the vehicle 102 may be configured to transmit audio signals associated with the audio content to other vehicles located in proximity to the vehicle 102 (not shown in FIG. 1), to enable all the vehicles to play the same audio content and facilitate the user(s) located at a predefined or a desired listening location/area (shown as desired listening location 306 in FIG. 3) to experience/hear the same audio content. The vehicle 102 may be connected to the other vehicles via a network (e.g., a network 110, described below) or via vehicle-to-vehicle communication (V2V) communication. In some aspects, the vehicle 102 serves as a “primary vehicle” that generates the audio content and transmits it to other vehicles, and the other vehicles serve as or become “replicators” for the audio signals associated with the audio content received from the primary vehicle/vehicle 102.

In some aspects, the vehicle 102 and the other vehicle described above may be communicatively coupled with an audio synchronization system 108. In some aspects, the audio synchronization system 108 (or system 108) may be part of a user device (e.g., a mobile device, a smartwatch, a tablet, etc., shown as user device 302 in FIG. 3) associated with a user (shown as user 304 in FIG. 3) who may be located at the desired listening location/area. In other aspects, the system 108 may be part of the vehicle 102 or another vehicle, which may be located at the desired listening location. In some aspects, the system 108 may be communicatively coupled the vehicle 102 and the other vehicles via a network 110 (or via V2V communication).

The network 110 illustrates an example communication infrastructure in which the connected devices discussed in various embodiments of this disclosure may communicate. The network 110 may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 108 may be configured to synchronize exterior audio systems (including the exterior audio systems 104) associated with the vehicle 102 and the other vehicles. Specifically, the system 108 may be configured to synchronize/coordinate the sound output from the exterior audio systems such that the user may experience an enhanced audio experience at the desired listening location/area. The system 108 may enable a shared and synchronized playback of the audio content at the desired listening location. In some aspects, to synchronize the exterior audio systems, the system 108 may synchronize each exterior audio system and optimize individual output from each exterior audio system at the desired listening location. The system 108 may be configured to determine a calibration setting for the exterior audio systems and cause each vehicle to operate their respective exterior audio systems based on the calibration setting to synchronize the exterior audio systems. For example, the system 108 may determine optimal playback delays and sound pressure levels for one or more exterior audio systems of each vehicle at the desired listening location, and then cause each vehicle to operate respective exterior audio systems based on the determined playback delays and sound pressure levels.

In some aspects, to determine the calibration setting for the exterior audio systems as described above, the system 108 may determine a position/location of each exterior audio system relative to the system 108 location and determine the calibration settings for the exterior audio systems based on the exterior audio systems' positions/locations. Responsive to determining the calibration setting, the system 108 may output/transmit information associated with the calibration setting to the respective vehicles (including the vehicle 102) to cause the vehicles to synchronize the respective exterior audio systems based on the calibration setting.

In addition, the system 108 may be configured to determine “usefulness” of each exterior audio system to play the audio content at the desired listening location and may select one or more exterior audio systems of each vehicle based on their respective usefulness. The system 108 may determine the usefulness based on the exterior audio system position/location and the desired listening location. Specifically, to determine whether an exterior audio system may be useful, the system 108 may determine whether the exterior audio system may be radiating sound waves/audio output towards or away from the desired listening location. The system may select the exterior audio system to play the audio content when the exterior audio system may be radiating sound waves/audio output towards the desired listening location and may not select the exterior audio system when the exterior audio system may be radiating sound waves/audio output away from the desired listening location. For example, the system 108 may select the exterior audio system 104a when the desired listening location may be in proximity to the vehicle front portion 106a. Responsive to the selection of the exterior audio systems as described above, the system 108 may determine the calibration settings of the selected exterior audio systems and output an instruction to the respective vehicles to activate the selected exterior audio systems based on the calibration settings (and not activate the other or “non-selected” exterior audio systems).

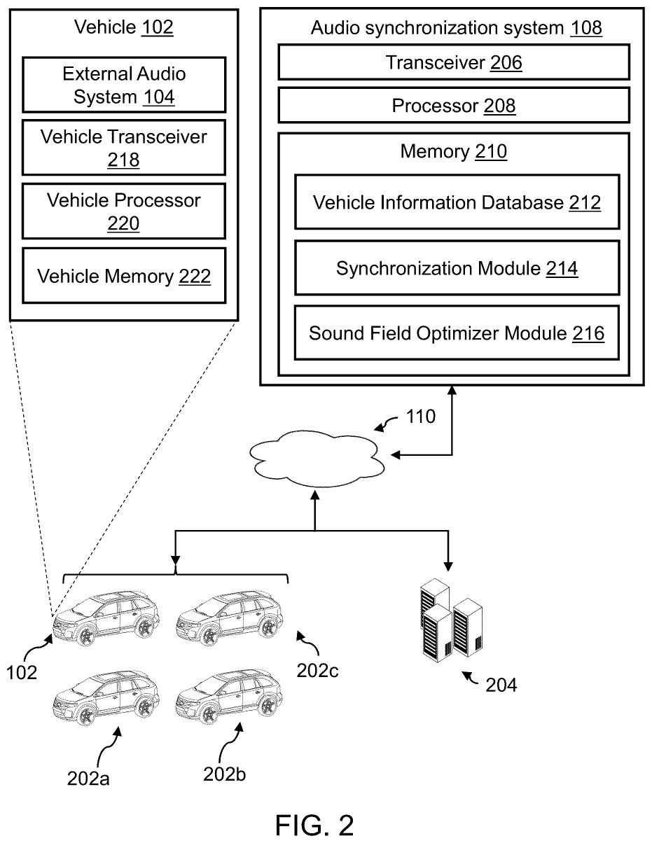

Further system 108 and vehicle 102 details are described below in conjunction with FIG. 2.

The vehicle 102 and the system 108 implement and/or perform operations, as described here in the present disclosure, in accordance with the owner manual and safety guidelines. In addition, any action taken by the operator/user associated with the vehicle 102 based on the notifications/recommendations provided by the system 108 should comply with all the rules specific to the location and operation of the vehicle 102 (e.g., Federal, state, country, city, etc.). The notifications/recommendations, as provided by the system 108, should be treated as suggestions and only followed according to any rules specific to the location and operation of the vehicle 102.

FIG. 2 depicts a block diagram of the audio synchronization system 108 and the vehicle 102 in accordance with the present disclosure. While describing FIG. 2, references will be made to FIGS. 3-5.

The system 108 may be communicatively coupled with a plurality of vehicles 102, 202a, 202b, 202c (collectively referred to as plurality of vehicles 202), via the network 110 (or via V2V communication). The system 108 may be further communicatively coupled to a server 204 (via the network 110) that may be part of a cloud-based computing infrastructure and may be associated with and/or include a Telematics Service Delivery Network (SDN) that provides digital data services to the vehicles 202 and/or the system 108. In some aspects, the server 204 may store a plurality of optimal vehicle configurations relative to the system 108 location and may transmit information associated with the optimal vehicle configurations to the system 108 (e.g., when the respective vehicles are in the audio synchronization mode). As discussed above in conjunction with FIG. 1, the system 108 may be part of a user device 302 (associated with a user 304, shown in FIG. 3) or a vehicle (not shown) that may be located at a predefined desired listening location/area 306.

The system 108 may include a plurality of units including, but not limited to, a transceiver 206, a processor 208 and a memory 210, which may be communicatively coupled to each other. The transceiver 206 may be configured to transmit/receive information/data/instructions to/from external systems and devices via the network 110. For example, the transceiver 206 may be configured to receive/transmit inputs/information/data/instructions from/to the vehicles 202, the server 204, and/or the like.

The processor 208 may be disposed in communication with one or more memory devices disposed in communication with the respective computing systems (e.g., the memory 210 and/or one or more external databases not shown in FIG. 2). The processor 208 may utilize the memory 210 to store programs in code and/or to store data for performing aspects in accordance with the disclosure. The memory 210 may be a non-transitory computer-readable storage medium or memory storing a program code that enables the processor 208 to perform operations in accordance with the present disclosure. The memory 210 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 210 may include a plurality of databases/modules including, but not limited to, a vehicle information database 212, a synchronization module 214, and a sound field optimizer module 216. The synchronization module 214 and the sound field optimizer module 216 may include and/or store computer executable instructions that may enable the processor 208 to perform one or more operations in accordance with the present disclosure. The function of the synchronization module 214 and the sound field optimizer module 216 may be understood in conjunction with the description provided later below.

The vehicle 102 (or other vehicles 202a, 202b, 202c) may include a plurality of units including, but not limited to, the exterior audio systems 104, a vehicle transceiver 218, a vehicle processor 220, and a vehicle memory 222, which may be communicatively coupled with each other. The vehicle transceiver 218 may be configured to transmit/receive information/data/instructions to/from external systems and devices via the network 110 (or via V2V communication). For example, the vehicle transceiver 218 may be configured to receive/transmit inputs/information/data/instructions from/to the system 108 (e.g., via the transceiver 206), the plurality of vehicles 202, the server 204, and/or the like.

The vehicle processor 220 may be disposed in communication with one or more memory devices disposed in communication with the respective computing systems (e.g., the vehicle memory 222 and/or one or more external databases not shown in FIG. 2). The vehicle processor 220 may utilize the vehicle memory 222 to store programs in code and/or to store data for performing aspects in accordance with the disclosure. The vehicle memory 222 may be a non-transitory computer-readable storage medium or memory storing a program code that enables the vehicle processor 220 to perform operations in accordance with the present disclosure. The vehicle memory 222 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In operation, when the plurality of vehicles 202 may be located in proximity to the desired listening location 306, the users associated with the vehicles 202 may activate a “participation” mode or an audio synchronization mode of their respective vehicles. The participation/audio synchronization mode may be a mode in which each vehicle 202 (e.g., the vehicle 102) may communicatively couple with other vehicles (e.g., the vehicles 202a, 202b, 202c) to output the same audio content towards the desired listening location 306, via the respective exterior audio systems. For example, each vehicle 202 may output the same audio content towards the desired listening location 306 when audio synchronization mode of each vehicle 202 may be activated. In some aspects, a user may activate the audio synchronization mode of a vehicle via a vehicle Human-Machine Interface (HMI) (not shown) of the vehicle, or via a user device associated with the user/vehicle.

In some aspects, the vehicle 102 may become “discoverable” by other vehicles located in proximity to the vehicle 102 (e.g., within a range of 8-12 meters), when the user activates the audio synchronization mode of the vehicle 102. Responsive to the vehicle 102 becoming discoverable, the plurality of vehicles 202 may communicatively couple or link with the vehicle 102 (and amongst each other after their respective audio synchronization modes are activated). In some aspects, a vehicle user associated with the vehicle 102 (that may serve as a “primary” vehicle) may view the discovered vehicles 202 at the vehicle HMI (or the user device) and may select one or more discovered vehicles (that may serve as “replicators”) to enable coupling of the vehicle 102 with the selected vehicles.

In an exemplary aspect, the vehicle processor 220 may be configured to determine that the vehicle 102 has entered the audio synchronization mode when the user activates the mode. Responsive to such determination, the vehicle processor 220 may obtain requests, via the vehicle transceiver 218, from vehicle processors of other vehicles 202 to communicatively couple with each other. The vehicle processor 220 may then accept the requests and connect with the other vehicles 202 to output the same audio content (that may be stored in the vehicle memory 222) at the desired listening location 306.

When the plurality of vehicles 202 may be linked/connected to each other as described above, the plurality of vehicles 202 may share an audio content amongst themselves (via the network 110 or the V2V communication) to play the same audio content, which may facilitate the user 304 to hear the same audio content at the desired listening location 306. In an exemplary aspect, the primary vehicle (e.g., the vehicle 102) may produce the audio content and transmit audio signals associated with the audio content to the replicator vehicles (e.g., the vehicles 202a, 202b, and/or 202c) via the vehicle transceiver 218. The replicator vehicles may receive the audio signals from the primary vehicle and may play the audio content via their respective exterior audio systems. In some aspects, the vehicle processor 220 may cause the exterior audio systems to play or produce the audio content (based on the calibration setting, described later below) and transmit the audio signals associated with the audio content to the replicator vehicles.

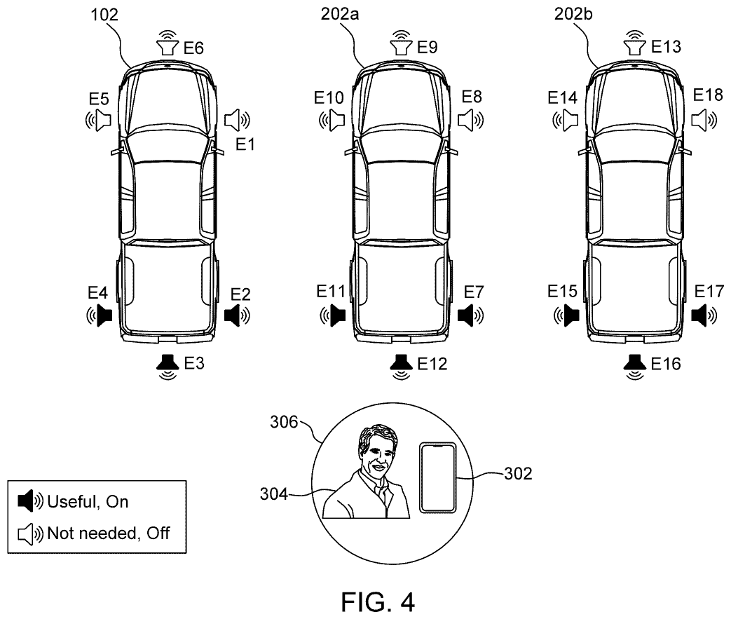

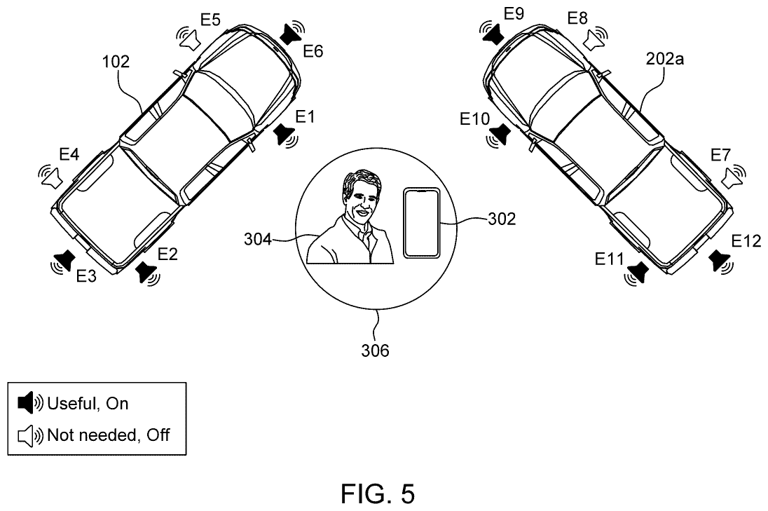

The plurality of vehicles 202 may be located in any configuration in proximity to the desired listening location 306. Example different vehicle configurations are depicted in FIGS. 3-5. FIG. 3 depicts an example first configuration in which the plurality of vehicles 202 (e.g., vehicles 102, 202a, 202b) may surround the desired listening location 306 from different listening location sides. Stated another way, in this configuration, the desired listening location 306 may be covered (or surrounded) by the vehicles 202 from a plurality of directions. Further, the vehicles 102, 202a, 202b may be located in different orientation. For example, the vehicles 102 and 202b may be located parallel to each other and at a predetermined distance away from each other, and the vehicle 202a may be located in between the vehicles 102 and 202b and perpendicular to them. FIG. 4 depicts an example second configuration in which the plurality of vehicles 202 (e.g., vehicles 102, 202a, 202b) are located parallel and adjacent to each other. Further, in this configuration, the back portions of the vehicles 202 may face the desired listening location 306. In an alternative configuration (not shown), the front portions of the vehicle 202 may face the desired listening location 306. FIG. 5 depicts an example third configuration in which the vehicles 202 (e.g., vehicle 102, 202a) may be oriented diagonally around (or inclined at a predefined non-zero, non-90 degree angle relative to) the desired listening location 306. The configurations or vehicle orientations depicted in FIGS. 3-5 are for illustrative purpose only, and should not be construed as limiting.

To synchronize the exterior audio systems associated with the vehicles 202 (that are in the audio synchronization mode) such the exterior audio systems optimally output the same audio content, the processor 208 associated with the system 108 may execute the instructions stored in the synchronization module 214 to determine calibration settings for the exterior audio systems associated with the vehicles 202 (to enable the user 304 to experience desired audio content at the desired listening location 306). Specifically, the processor 208 may determine optimal time delays (or playback delays) and sound pressure levels associated with the sound output of the exterior audio systems of each vehicle, so that the audio content may be optimally heard/received from each exterior audio system without any lag at the desired listening location 306. In some aspects, to determine the calibration setting for the exterior audio systems, the processor 208 may first determine a position of each exterior audio system of each vehicle 202. The processor 208 may determine the position by using any method. Example methods for position determination are described below; however, the methods described below should not be construed as limiting.

In an exemplary aspect, when the system 108 and the vehicles 202 may be located in a quiet environment (i.e., when an ambient noise level may be below a threshold value), the processor 208 may transmit a request to the vehicle processors (including the vehicle processor 220, via the transceiver 206 and the vehicle transceiver 218) to produce/output test audio signals sequentially via their respective exterior audio systems. In some aspects, the processor 208 may transmit such requests sequentially so that the vehicles 202 may play/output the test audio signals one at a time. For example, the processor 208 may transmit the request to the vehicle 102 to produce a test audio signal at time “T”=T1 and request the vehicle 202a to produce a test audio signal at “T”=T7. In some aspects, the processor 208 may request the vehicle processors to play the test audio signals from all their exterior audio systems (E1-E18, shown in FIG. 3) in a sequential manner, one at a time. For example, the processor 208 may transmit the request to the vehicle processor 220 to play the test audio signal from an exterior audio system “E1” at time “T”=T1, from “E2” at time “T”=T2, from “E3” at “T”=T3, and so on. Similarly, the processor 208 may transmit the request to the vehicle processor of the vehicle 202a to play the audio signal from “E7” at “T”=T7, from “E8” at “T”=T8, and so on. The respective vehicle processors may obtain/receive the requests and may play/output the test audio signal based on the requests. In some aspects, the vehicle processors may produce a combination of pink noise, sine sweep, or chirp signals (as test audio signals) from each exterior audio system responsive to obtaining the requests.

The transceiver 206 (that may be a microphone) may receive the test audio signals from respective exterior audio systems, when the exterior audio systems E1-E18 play/output the test audio signal. The transceiver 206 may further transmit information/inputs associated with each received test audio signal to the processor 208. In some aspects, the information/inputs associated a test audio signal may include a time-of-flight information associated with the test audio signal. The time-of-flight information indicates time taken by the audio signal to travel from the respective exterior audio system to the system 108. In addition, the information may include an identifier associated with the respective exterior audio system from where the test audio signal is received. In some aspects, the transceiver 206 may further store the information/inputs associated with the test audio signals in the vehicle information database 212.

The processor 208 may obtain the information from the transceiver 206 (or from the vehicle information database 212) and may determine location/position of each exterior audio system relative to the system 108 based on the obtained information. Specifically, the processor 208 may use the time-of-flight information to determine the distance of the exterior audio systems E1-E18 relative to the system 108 (located in the desired listening location 306). For example, the processor 208 may determine that the exterior audio system E2 is closer to the system 108 than the exterior audio system E5. In addition, the processor 208 may determine that the exterior audio systems E2 and E5 belong to the vehicle 102 based on the identifiers associated with the exterior audio systems E2 and E5. Further, the processor 208 may determine that the exterior audio systems El and E2 are at a vehicle passenger side, and E4 and E5 are at a vehicle driver side. Further, the processor 208 may determine the vehicle orientation based on the time-of-flight and identifier information. For example, the processor 208 may determine that the vehicle 102 may be located in a vertical orientation with the driver side exterior audio systems facing away from the desired listening location 306 based on the time-of-flight and identifier information. The processor 208 may store the orientation information described above associated with each exterior audio system in the vehicle information database 212. In an exemplary aspect, the processor 208 may store a mapping of each exterior audio system identifier with the corresponding vehicle and the determined distance relative to the system 108 in the vehicle information database 212.

In another exemplary aspect, when the system 108 and the vehicles 202 may be located in a loud environment (i.e., when the ambient noise level may be above the threshold value), the processor 208 may use wireless positioning technology to determine the position/location of the exterior audio systems E1-E18 relative to the system 108. The wireless positioning technology may use devices including, but not limited to, an ultra-wideband (UWB) transceiver, a Bluetooth transceiver, a gyroscope, a compass, a Global Positioning System (GPS) receiver, and/or the like. In some aspects, the processor 208 may obtain the vehicle position information from the plurality of vehicles 202, via the transceiver 206, and may use wireless positioning technology and the vehicle position information to determine the position/location of the exterior audio systems El-E18 relative to the system 108.

Responsive to determining the position/location of the exterior audio systems E1-E18 relative to the system 108 as described above, the processor 208 may determine the calibration setting for the exterior audio systems El-E18 based on the determined position/location. As described above, the calibration settings may include optimal time delays (or playback delays) and sound pressure levels associated with the sound output from the exterior audio systems E1-E18, so that the audio content may be optimally heard/received from each exterior audio system without any lag at the desired listening location 306. Responsive to determining the calibration settings for the exterior audio systems E1-E18, the processor 208 may store the calibration settings in the vehicle information database 212.

In addition, the processor 208 may output/transmit the information associated with the calibration settings to the respective vehicles 202 to cause synchronization of the exterior audio systems E1-E18 based on the calibration settings. For example, the processor 208 may transmit, via the transceiver 206, the calibration setting information associated with the exterior audio system E2 (along with the identifier) to the vehicle transceiver 218. The vehicle transceiver 218 may receive/obtain the calibration setting information associated with E2 from the transceiver 206 and may transmit the calibration setting information to the vehicle processor 220. The vehicle processor 220 may obtain the calibration setting information and may control/activate the exterior audio system E2 based on the calibration setting information. Similarly, the processor 208 may transmit the calibration setting information associated with E1, E3, E4, etc. to the vehicle transceiver 218/vehicle processor 220, and the vehicle processor 220 may accordingly control/activate the exterior audio systems E1, E2, E3, etc. based on the calibration setting. For example, the vehicle processor 220 may active E2 with a first-time delay, E3 with a second-time delay, and so on, based on the respective calibration settings.

In additional or alternative aspects, the processor 208 may execute the instructions stored in the sound field optimizer module 216 to determine a “usefulness” of each exterior audio system to produce the audio content at the desired listening location 306 and select one or more exterior audio systems of each vehicle to activate based on the determination, to optimize sound field that may be received at the desired listening location 306 (and to prevent excessive sound pollution). The processor 208 may determine the usefulness of each exterior audio system based on the exterior audio system position/location and the desired listening location 306. For example, the processor 208 may determine whether E2 may be useful to output/play audio signal based on the location/orientation of E2 relative to the desired listening location 306. Since 2 may be radiating audio signals towards the desired listening location 306, the processor 208 may determine that E2 is useful for outputting the audio content towards the desired listening location 306. Similarly, the processor 208 may determine that E5 may not be useful as E5 may be radiating audio signals away from the desired listening location 306. Responsive to such determination, the processor 208 may select E2 to output audio signals and may not select E5 to play the audio content/signals. As another example, the processor 208 may select exterior audio systems located on the passenger side of each vehicle, as the passenger side may be facing towards the desired listening location 306.

Responsive to selecting the “useful” exterior audio systems of each vehicle, the processor 208 may output/transmit an instruction (e.g., a first instruction) to the respective vehicle (each vehicle) based on the selected useful exterior audio systems. The instruction may include identifiers of the selected useful exterior audio systems and a command signal to activate the selected useful exterior audio systems (and not activate the other exterior audio systems, thereby preventing noise pollution). In an exemplary aspect, the processor 208 may transmit, via the transceiver 206, the first instruction to the vehicle transceiver 218, which may transmit the first instruction to the vehicle processor 220 to cause activation of E2. The vehicle processor 220 may obtain the first instruction and may control/activate the respective exterior audio system (e.g., E2) based on the first instruction. In some aspects, the processor 208 may activate the exterior audio system (e.g., E2) based on the first instruction and the calibration settings associated with E2.

In some aspects, the processor 208 may first select the useful external audio systems for each vehicle, and then determine the calibration setting for the selected useful external audio systems. The processor 208 may then output/transmit the first instruction to activate the selected useful exterior audio systems based on the determined calibration setting. In alternative aspects, the processor 208 may skip the step of selecting the useful external audio systems and may instead cause the vehicles 202 to activate all their exterior audio systems based on respective calibration settings. Stated another way, the step of selecting the useful external audio systems should not be construed as necessary for the present disclosure.

In further aspects, the processor 208 may determine audio channel assignment in stereo configuration for each selected useful exterior audio system based on the exterior audio system location/position and may accordingly adjust the calibration setting. For example, in the first configuration (shown in FIG. 3), the processor 208 may select exterior audio systems E1, E2, E3, E6, E7, E8, E9, E12, E13, E14, E15, E16 to play the audio content based on the location of these exterior audio systems relative to the desired listening location 306. The processor 208 may further assign E1, E2, E3, E6, E7, and E12 as left channel in the stereo configuration and may assign E8, E9, E13, E14, E15, and E16 as right channel in the stereo configuration based on the location and orientation of the plurality of vehicles 202 in proximity to the desired listening location 306 (that may be determined based on the time-of-flight information as described above). Further, the processor 208 may determine whether a stereo or sound application may be appropriate based on the audio content and may cause the vehicles 202 to play the audio content based on the determined application/configuration.

Similar to the first configuration, the processor 208 may select E2, E3, E4, E7, E11, E12, E15, E16, and E17 to play the audio content in the second configuration (shown in FIG. 4), as these exterior audio systems may be useful. In the third configuration (shown in FIG. 5), the processor 208 may select E1, E2, E3, E6, E9, E10, E11, E12 to output the audio content.

In further aspects, the processor 208 may identify or determine an optimal position (relative to the desired listening location 306) of the plurality of vehicles 202 for best playback at the desired listening location 306, based on the position of each exterior audio system. In some aspects, the processor 208 may determine the optimal position based on the information associated with the optimal vehicle configurations stored in the server 204. The processor 208 may then compare the optimal position with the respective current vehicle position. Based on the comparison, the processor 208 may determine whether the current vehicle position matches with the optimal position for best playback at the desired listening location 306. Responsive to a determination that the current vehicle position is not the optimal position, the processor 208 may transmit/output another instruction (e.g., a second instruction having a command signal) to the respective vehicles to move to the optimal position (e.g., using acoustic positioning, wireless positioning, etc.). The vehicles may receive the second instruction and may autonomously move to the optimal position responsive to obtaining the second instruction.

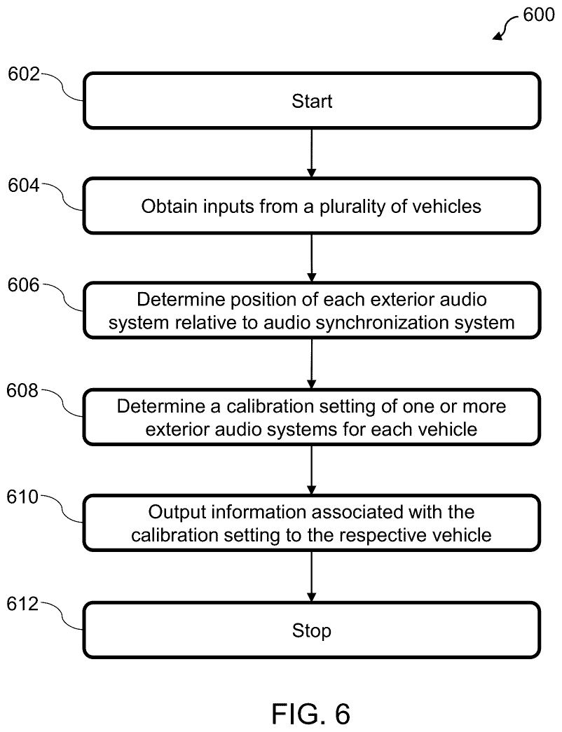

FIG. 6 depicts a flow diagram of an example audio synchronization method 600 in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 208, inputs from the plurality of vehicles 202 via the transceiver 206. As described above, each vehicle may include a plurality of exterior audio systems disposed at a vehicle exterior surface. In some aspects, the inputs may include time-of-flight information associated with each audio signal produced by each exterior audio system. In further aspects, the inputs may include the vehicle position information.

At step 606, the method 600 may include determining, by the processor 208, a position of each exterior audio system relative to the system 108 based on the obtained inputs. At step 608, the method 600 may include determining, by the processor 208, a calibration setting of one or more exterior audio systems for each vehicle based on the position. The calibration setting may include a time delay and a sound pressure level. At step 610, the method 600 may include outputting, by the processor 208, information associated with the calibration setting to the respective vehicle to cause the vehicle to synchronize the exterior audio systems based on the calibration setting.

At step 612, the method 600 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An audio synchronization system comprising:
a transceiver configured to obtain inputs from one or more vehicles, wherein each vehicle comprises one or more exterior audio systems disposed at a vehicle exterior surface;
a processor communicatively coupled to the transceiver, wherein the processor is configured to:
obtain the inputs from the transceiver;
determine a position of each exterior audio system relative to the audio synchronization system based on the inputs;
determine a calibration setting of one or more exterior audio systems for each vehicle based on the position; and
output information associated with the calibration setting to each vehicle to cause each vehicle to synchronize the one or more exterior audio systems based on the calibration setting.

2. The audio synchronization system of claim 1, wherein the processor is further configured to:
transmit, via the transceiver, a request to each vehicle to produce audio signals sequentially using the exterior audio systems; and
obtain, via the transceiver, the inputs from each vehicle responsive to transmitting the request.

3. The audio synchronization system of claim 2, wherein the inputs comprise a time-of-flight information associated with each audio signal.

4. The audio synchronization system of claim 1, wherein the inputs comprise a vehicle position information.

5. The audio synchronization system of claim 1, wherein the calibration setting comprises a time delay and a sound pressure level.

6. The audio synchronization system of claim 1, wherein the processor is further configured to:
select the one or more exterior audio systems from the one or more exterior audio systems for each vehicle based on the position of each exterior audio system; and
determine the calibration setting for the one or more exterior audio systems based on the position.

7. The audio synchronization system of claim 6, wherein the processor is further configured to output a first instruction to each vehicle responsive to selection of the one or more exterior audio systems, and wherein the first instruction comprises a command signal to activate the one or more exterior audio systems based on the calibration setting.

8. The audio synchronization system of claim 6, wherein the processor is further configured to:
identify an optimal position of the one or more vehicles based on the position of each exterior audio system relative to the audio synchronization system;
compare the optimal position with respective current vehicle positions; and
output a second instruction to one or more of the one or more vehicles based on comparing the optimal position with respective current vehicle positions, wherein the second instruction comprises a command signal to move the one or more vehicles to the optimal position.

9. A first vehicle comprising:
a plurality of exterior audio systems disposed at a vehicle exterior surface;
a vehicle transceiver configured to communicate with an external audio synchronization system; and
a vehicle processor communicatively coupled to the vehicle transceiver and the plurality of exterior audio systems, wherein the vehicle processor is configured to:
obtain inputs from the vehicle transceiver, wherein the inputs comprise a calibration setting information associated with one or more exterior audio systems of the plurality of exterior audio systems, and wherein the calibration setting information is based on positions of the one or more exterior audio systems relative to the external audio synchronization system; and
activate the one or more exterior audio systems based on the calibration setting information.

10. The first vehicle of claim 9, wherein the vehicle processor is further configured to:
obtain a first instruction from the external audio synchronization system, wherein the first instruction comprises a command signal to activate the one or more exterior audio systems selected by the external audio synchronization system; and
activate the one or more exterior audio systems based on the first instruction.

11. The first vehicle of claim 9, wherein each of the plurality of exterior audio systems comprises a vibration audio exciter.

12. The first vehicle of claim 9, wherein each of the plurality of exterior audio systems comprises a vehicle speaker.

13. The first vehicle of claim 9, wherein the vehicle processor is further configured to:
obtain a second instruction from the external audio synchronization system, wherein the second instruction comprises a command to move the first vehicle to an optimal position relative to the external audio synchronization system; and
cause the first vehicle to move to the optimal position based on the second instruction.

14. The first vehicle of claim 10, wherein the vehicle transceiver is further configured to obtain a request from a second vehicle to communicatively couple with the first vehicle.

15. The first vehicle of claim 14, wherein the vehicle processor is further configured to:
determine that the first vehicle is in an audio synchronization mode, wherein the first vehicle is configured to communicatively couple with a plurality of additional vehicles to output same audio content when the first vehicle is in the audio synchronization mode;
obtain the request from the vehicle transceiver, responsive to determining that the first vehicle is in the audio synchronization mode; and
communicatively couple with the second vehicle responsive to obtaining the request.

16. The first vehicle of claim 15, wherein the vehicle processor is further configured to:
output an audio content via the one or more exterior audio systems based on the calibration setting; and
transmit audio signals associated with the audio content to the second vehicle, responsive to communicatively coupling with the second vehicle.

17. A non-transitory computer-readable storage medium having instructions stored thereupon which, when executed by a processor, cause the processor to:
obtain inputs from a plurality of vehicles, wherein each vehicle comprises a plurality of exterior audio systems disposed at a vehicle exterior surface;
determine a position of each exterior audio system relative to an audio synchronization system based on the inputs;
determine a calibration setting of one or more exterior audio systems for each vehicle based on the position; and
output information associated with the calibration setting to each vehicle to cause each vehicle to synchronize the one or more exterior audio systems based on the calibration setting.

18. The non-transitory computer-readable storage medium of claim 17, wherein the inputs comprise a time-of-flight information associated with each audio signal.

19. The non-transitory computer-readable storage medium of claim 17, wherein the inputs comprise a vehicle position information.

20. The non-transitory computer-readable storage medium of claim 17, wherein the calibration setting comprises a time delay and a sound pressure level.
